(19) United States
(12) Patent Application Publication
(10) Pub. No.: US 2003/0121972 A1
(43) Pub. Date: Jul. 3, 2003

(54) System for providing medical service using electronic cards and a method thereof

(76) Inventors: Seung Kuk Lee, Seoul (KR); Myeng Ki Kim, Seoul (KR)

Correspondence Address: FOLEY AND LARDNER, SUITE 500, 3000 K STREET NW, WASHINGTON, DC, 20007, US

(21) Appl. No.: 10/257,650

(22) PCT Filed: Feb. 15, 2002
(86) PCT No.: PCT/KR02/00234

(30) Foreign Application Priority Data
Feb. 16, 2001 (KR) 2001/7833

(51) Int. Cl. G06K 5/00

(52) U.S. Cl. 235/380

(57) ABSTRACT

The present invention relates to a system for providing medical service using electronic cards and a method thereof, and in particular, to a technique which enables personal medical information to be managed by using intelligent cards. According to the present invention, personal health information is written on intelligent cards (hereinafter, referred to as IC card), and medical treatment or drug dispensing is performed by referring to health information written on the IC cards. In addition, the present invention enables hospitals and medical institutions (for example, the medical insurance management corporation or private insurance companies) to share personal health information, connected with each other through the Web. Here, personal health information is safely protected because certification procedures are performed by using IC cards among the institutions and then the information can be shared only after succeeding in certification. The present invention is also characterized in that these IC cards can be incorporated into banking cards such as debit cards or credit cards. Accordingly, the present invention enables many certified institutions to share personal health information, thereby establishing the reliable medical system. The present invention also enables hospitals and pharmacies to grasp personal health situation exactly by providing the optimum medical service.

### BACKGROUND OF THE INVENTION

1. Field of the Invention

The present invention generally relates to a system for providing medical service using electronic cards and a method thereof, and particularly, to a technique which enables personal medical information to be managed by using intelligent cards.

2. Description of the Prior Art

Medical institutions, pharmacies and other groups requiring medical information have exchanged and transferred the medical information each other using paper documents or the Internet. However, when medical information is transferred, using paper documents including simple contents, there are many restrictions on efficient medical performance to patients. In addition, in case of using the Internet, it has problems in security because there are possibilities of important medical information of individuals being changed or exposed.

Generally, in case of transferring prescription, drug can be dispensed according to prescription only after patients are treated by physicians, prescription according to the medical treatment is issued to the patients, and then the issued prescription is presented to pharmacy.

In this system, a view of a physician is transferred to a pharmacist via prescription. However, pharmacists cannot examine details of prescription with reference to medical history of patients because details of prescription according to the present condition of patients are just described in this prescription.

Additionally, after issuing prescriptions to patients, physicians cannot ascertain whether drug of the patients is dispensed according to the prescriptions. As a result, the physicians cannot know whether the patients have taken the medicine when they come to hospital again.

### SUMMARY OF THE INVENTION

Accordingly, an object of the present invention is to utilize IC cards as means of security in transmitting and receiving medical information and then make the IC cards certificated when medical institutions, pharmacies and other groups requiring medical information are provided with results of medical treatment and use the results.

Another object of the present invention is to store all the records of a patient in one electronic card by recording•storing details of medical treatment, prescription and dispensing of the patient in the electronic card such as an IC card.

Another object of the present invention is to provide users such as physicians, pharmacists and nurses with user cards and then allow them to store and inquire information on patient electronic cards according to rights of each card.

Another object of the present invention is to allow pharmacists and physicians to share patient information and then provide the best medical service according to the condition of patients.

Another object of the present invention is to provide medical service by using electronic cards comprising the reliable certification system. The system never allows people to access patient information without succeeding in certification by password or certification key although they have patient cards, user cards and master cards.

Another object of the present invention is to provide various institutions with health information of individuals by (1) offering and administering results of medical treatment in pharmacy or hospital to medical institutions operated by co-operations or groups (for example, National Health Insurance Cooperation) and (2) transmitting practical records of medical treatment of patients and records of medical treatment reported from hospital and pharmacy to patients or medical institution.

There is provided a system for providing medical service using electronic cards comprising hospital system for previously storing the information on patients having records of medical treatment and on users (physicians, nurses, pharmacists) involved in practice of medical treatment, including: electronic cards issued according to rights of users and for recording various information on medical service for patients; a main server of hospital for registering new electronic cards and inquiring•recording the registered electronic cards after storing the information of the hospital system in a separate database; a hospital client connected to the main server, and for registering new electronic cards and inquiring•recording the registered electronic cards; and a pharmacy client for inquiring the prescription information recorded in patient cards and recording the dispensing information on the prescription information in the patient cards wherein the main server and the clients include a card reader for reading the information stored in the electronic cards and recording predetermined information in the cards, and an operator terminal for inputting instruction and outputting the process of instruction execution.

There is a method of providing medical service using electronic cards comprising hospital system for storing the information on users (physicians, nurses, pharmacists) involved in medical practice and on patients having records of medical treatment, including: the first step of transforming the information stored in the hospital system into the standardization codes and then storing the standardization codes; the second step of enabling users having registering rights to register new electronic cards into user cards or patient cards; and the third step of transmitting the electric medical information on users of the registered cards.

There is another method of providing medical service using the system wherein servers for administering health information of patients are installed in a plurality of hospitals, a plurality of pharmacies and a plurality of medical institutions, respectively, the servers connected through the Internet are installed, and electronic cards having individually allotted values of specific keys are issued to according to the patients, including: the first step of enciphering health information corresponding to the patients using the values of the keys allotted in electronic cards issued to the patients and then transmitting the information into a relevant server in a predetermined transmission server for transmitting the information corresponding to the patients; and the second step of decoding the transmitted health information using the values of keys allotted in electronic cards issued to the patients and then certifying the information in the relevant server.

### BRIEF DESCRIPTION OF THE DRAWINGS

The present invention will be explained in terms of exemplary embodiments described in detail with reference to the accompanying drawings, which are given only by way of illustration and thus are not limitative of the present invention, wherein:

FIG. 1 is a block diagram illustrating a system for providing medical service using electronic cards in accordance with a preferred embodiment of the present invention;

FIGS. 2 through 6b are a flow chart for explaining a method of providing medical service using electronic cards in accordance with a preferred embodiment of the present invention;

FIG. 7 is a block diagram illustrating a system for providing medical service using electronic cards in accordance with another preferred embodiment of the present invention;

FIG. 8 is a flow chart for explaining a method of providing medical service using electronic cards in accordance with another preferred embodiment of the present invention.

### DETAILED DESCRIPTION OF THE PREFERRED EMBODIMENTS

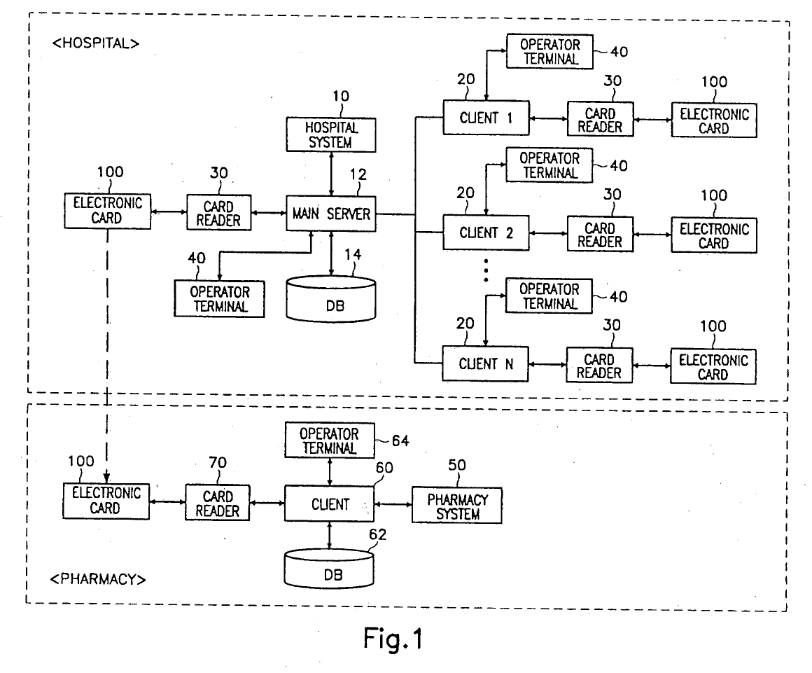

FIG. 1 is a block diagram illustrating a system for providing medical service using electronic cards in accordance with a preferred embodiment of the present invention.

As shown in FIG. 1, an electronic medical information transmission system is formed of constitutions installed in hospital and pharmacy linked with each other.

A hospital system 10, a main server 12, a client 20 and a card reader 30 are formed in hospital.

The hospital system 10 administers data according to medical treatment of patients, comprising a database for storing information on patients having records of medical treatment and on users (for example, physicians, nurses and pharmacists) involved in medical practice.

The main server 12 reads the data stored in the database of the hospital system 10 during initial driving, and then stores the standardized data (for example, ICD(International Classification of Disease)—10 used as a disease code) in a database 14. The main server 12 finally registers user/patient cards, and inquires/records patient cards.

The client 20 registers patient cards and inquires/writes patient cards, connected to the main server 12.

The card reader 30 serves as a medium for enabling the main server 12, the client 20 or a electronic card 100 to read/write information, connected to the main server 12 or the client 20.

It is desirable to communicate between the hospital system 10 and the main server 12, and the main server 12 and the client 20, based on the Internet, Lan and Serial.

An operator terminal 40 for inputting instructions and outputting results according to the inputted instructions is installed in the main server 12 and the client 20. There are a keyboard, a monitor and a printer as the operator terminal 40.

In pharmacy, a pharmacy system 50, a client 60 and a card reader 70 are formed.

The pharmacy system 50 administers data on dispensing drug of patients, comprising a database for storing information on patients having dispensing records and on users (for example, pharmacists) involved in dispensing practice.

The client 20 reads the data stored in the database of the pharmacy system 10, and stores the standardized data in a database 62. Then, the client 20 inquires/records patient cards for dispensing.

The card reader 70 serves as a medium for enabling the client 20 and an electronic card to read/write information therebetween, connected to the client 20.

An operator terminal 40 for inputting instructions and outputting results according to the inputted instructions is installed in the client 20.

An electronic card 100 used in hospital and pharmacy desirably has a built-in IC chip. In general, the electronic card 100 is divided into a master card for the main server, a master card for the client and a patient/user card. The master card for the main server operates the main server 12 in hospital. The master card for the client operates the clients 20 and 60. The patient/user card stores information on patients and users and then transmits electronic medical information using an electronic card.

The electronic card is more desirably used in connection with cards for transportation and banking cards including electronic funds transfer cards, credit cards debit cards although this card can be exclusively used in health cards, certification of medical information transmission and electronic medical information transmission. As described above, in case of using the electronic card in connection with banking cards or transportation cards, an element file EF formed in the IC card includes an element file EF for storing data according to banking/transportation and another element file EF of a dedicated file DF for storing data according to transmission of the electronic medical information, separately. The element file EF for storing data according to transmission of the electronic medical information stores initial keys and passwords at a point of issuing the card. The initial keys and passwords are changed into different keys and passwords and then when cards are registered.

Additionally, a chip operating system is mounted in the IC card. A certification procedure is performed by storing data or using keys and passwords.

The certification procedure is performed using an authorized algorithm (for example, 3Des, RSA and etc.) A certification procedure, which is performed using the keys and passwords in 3Des, will be explained.

The certification procedure using the keys generates a random number based on keys stored in the element file of the electronic card, and transmits a value of the code into a main server or a client. Then, the main server or the client generates a new certification key from the registered keys and the random number, and transmits a value of the generated certification key into the electronic card. Here, the electronic card generates a certification key from the keys stored in the electronic card and the generated random number. If the certification key is identical with the transmitted certification key, the electronic card transmits a message for approving a certification key into the main server or the client.

The certification procedure using the password is to transmit a message for approving a certification password into the main server or the client, when a value for generating a random number corresponding to a password stored in a predetermined area of the electronic card is identical with a value for generating a random number corresponding to a password inputted via the operator terminal 40 of the main server or the client.

The main server 12, the hospital client 20 and the pharmacy client 60 comprise applied programs as follows.

The main server 12 comprises applied programs for registration of new user/patient cards, for inquiry/record of patient cards and for standardization of codes.

The hospital client 20 comprises applied programs for registration of new patient cards and for inquiry/record of patient cards.

The pharmacy client 60 comprises an applied program for dispensing drug using patient cards.

The hospital database 14 stores a code including information on patients and users stored in the database of the hospital system 10, the code changed according to a standardized code system. Here, the information on patients and users includes various information on users, individuals, priority, medical insurance, medical treatment, medication, emergency, rights of medical treatment, records of medical treatment and examination. Identity of the pertinent subject can be identified on the basis of the information on priority and users.

The user information is to classify persons having medical-related occupations into physicians, nurses, auxiliary nurses, emergency rescuers, and so on.

The personal information includes individual time information on individual full name, identification number and address.

The priority information is to ascertain whether a pertinent medical institution uses the system.

The medical insurance information includes information related to medical insurance such as insurance institutions and insurance numbers given by national or medical-related institutions.

The medical treatment information includes information on medical institutions, dates of medical treatment, departments of medical treatment and physicians.

The medication information includes information on medical institutions, dates of medical treatment, departments of medical treatment and dosage of drug according to prescription.

The emergency information includes information on blood types, histocompatibility types, medicine to be taken or not to be taken and contents of the intestine function.

The medical treatment right information includes information on patient numbers of each medical institution.

The medical treatment record information includes information on medical institutions, dates of medical treatment, departments and physicians.

The examination information includes information on medical institutions, and dates, titles and results of examination.

In the present invention, information on users, individuals, medical insurance, medical treatment, medication, emergency, rights of medical treatment, records of medical treatment and examination is stored according to an independent code system of the hospital system 104. Each code value of the above-described information is changed by applying to a standardized code system recognizable in other medical institutions, and then stored in the database 14. Thereafter, data formed of the code value according to the standardized code system is stored in the electronic card 100.

In the pharmacy database 62, a standardized code value to the user/patient information stored in the database of the pharmacy system 50 is changed into an available code system in the pharmacy system 50. Then, the changed code value is stored into information on patients and users.

Hereinafter, a method of transmitting electronic medical information using electronic cards in accordance with a preferred embodiment of the present invention will be explained in detail with reference to the accompanying flow chart.

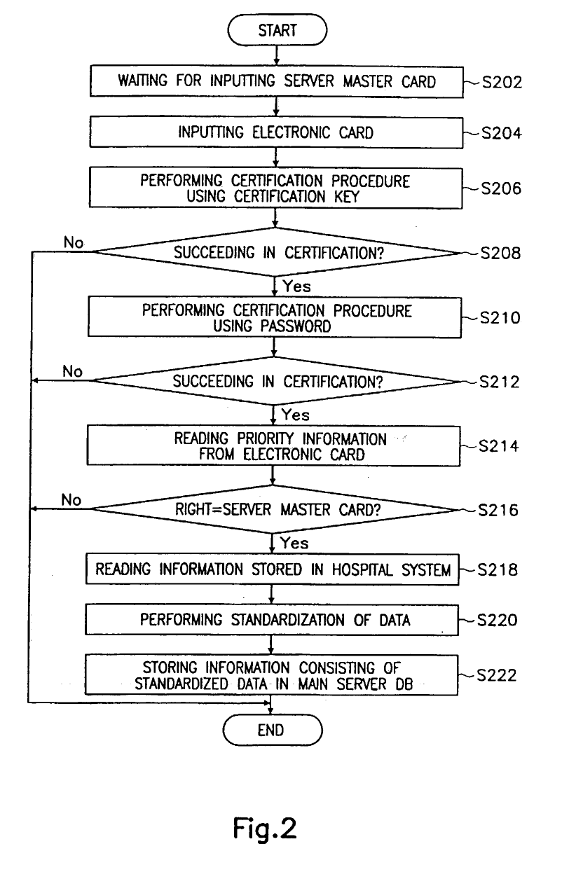

FIG. 2 is a flow chart for explaining an operation according to the initial driving of the main server 12 in a method of providing medical service using electronic cards in accordance with a preferred embodiment of the present invention.

If drive of the main server 12 is commanded by the operator terminal 40, the main server 12 calls an input of the server master card to the operator terminal 40 and then waits for the input of the server master card (S202).

If a predetermined electronic card is inputted via the card reader 30 connected to the main server 12 (S204), the electronic card 100 and the main server 12 perform the certification procedure using keys, and ascertain whether a certification key generated from the key stored in the electronic card 100 is identical with a certification key generated from the key stored in the main server 12 (S206) After confirming the identification of certification keys in the electronic card 100, the electronic card 100 transmits a certification success message into the main server 12. If the main server 12 receives the certification success message of the certification key, the main server 12 judges that certification using certification keys succeeds (Yes in S208).

Thereafter, the main server 12 transmits a built-in password into the electronic card 100, and performs the certification procedure using the password (S210).

The electronic card 100 transmits values for generating random numbers to the previously registered password and to the password that the main server 12 inputs in the operator terminal 40, and compares them. If the values are identical with each other, the main server judges that both passwords are identical with each other. According to this result, the electronic card 100 transmits a message of approving password certification into the main server 12. If the message of approving password certification is transmitted, the main server 12 judges that the certification procedure using passwords succeeds (Yes in S212), and reads the priority information stored in the electronic card 100 (S214).

The main server 12 judges if the electronic card 100 is a server master card, based on the read priority information. If the priority information is registered in the server master card, the main server 12 reads the priority information as the server master card and then performs certification procedure (Yes in S216).

Thereafter, the main server 12 reads the information on patients and users stored in the database in the hospital system 10 (S220), and performs standardization for transforming a code value corresponding to the information on patients and users into a standardized code value (S222). Then, the main server 12 stores the standardized code value in the database 14 (S224).

The above-described steps S218 and S222 correspond to interface work between the hospital system 10 and the main server 12. If is desirable that the interface work is repeatedly performed.

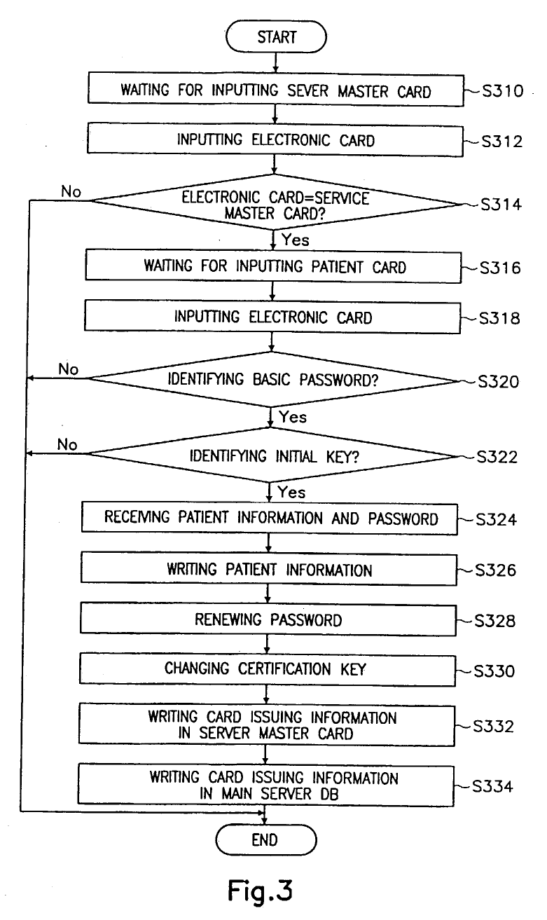

FIG. 3 is a flow chart for explaining the process of issuing new electronic cards in the main server 12 in accordance with a preferred embodiment of the present invention.

After the main server 12 is driven, the operator terminal 40 selects an issuing function. The main server 12 calls input of a server master card to the operator terminal 40 using an applied program in the main server 12, and then waits for the input of the server master card (S310).

Under this condition, if a predetermined electronic card 100 is inserted via the card reader 30 connected to the main server 12 (S312), the main servers 12 judges if the electronic card 100 is a server master card (S314).

The judging step of S314 corresponds to the steps of S206˜S215 in FIG. 2.

If the inputted electronic card 100 is judged as a server master card in the step of S314, the main server 12 calls input of new electronic cards to the operator terminal 40 and then waits for the input of new electronic cards (S316). Here, new electronic cards are patient cards.

If a predetermined electronic card 100 is inputted via the card reader 30 (S318), the main server 12 ascertains whether the electronic card is a card to be registered newly (S320, S322).

When new electronic cards are issued as banking cards or transportation cards, initial key values and passwords are stored at the IC cards. If the main server 12 transmits the previously registered initial password into the electronic card 100 for confirmation of a new card, it judges if the currently stored password is identical with the password transmitted from the main server 12. When both passwords are identical in the certification procedure, a message of approving password certification is transmitted into the main server 12. A certification procedure is performed using a certification key generated from initial key values and a certification key generated from the main server 12 (Yes in S320).

If the certification keys resulting from the certification procedure are identical, the server master card transmits a message of approving certification of the certification key (Yes in S322), and the main server 12 receives personal information on patients and a password to be changed via the operator terminal 40 (S324). When the main server 12 receives the password, the password is twice inputted for a precise input. Then, the main server 12 operates only when the inputted password is identical.

After the password is successfully inputted in the above process, the main server 12 records patient information in the new electronic cards via the card reader 30. The recorded information is various information on personal identification, priority, medical insurance, emergency, vaccinations, medical treatment rights, medical history, emergency records, medical treatment, medication, examination and so on. The priority information is to classify rights. If the priority is recorded as patients, the new electronic cards become patient cards. If the priority is recorded as physicians, nurses and pharmacists, the new electronic cards become user cards. The user cards may be registered only in the main server 12 so that predetermined administrators may determine users of medical institutes. In addition, the priority information is stored in master cards to classify server master cards and client master cards.

Thereafter, the main server 12 records the password successfully inputted in the step of S324 in the new electronic card via the card reader 30 (S328). Then, the main server 12 changes key values and records them in the new electronic card (S330).

The main server 12 records information on the issued cards in server master cards via the card reader 30 (S332), and also records the information in the database 14 (S334).

The hospital client 20 can register new electronic cards as patient cards according to the procedure described in FIG. 3, just as the main server 12 does as described above.

The procedure for registering new electronic cards can also be performed in financial or governmental institutes, just as the main server 12 and the client 20 do.

The new electronic cards are registered as patient cards or user cards by renewing and storing personal information and password or by changing key values for generating certification keys.

The write and inquiry operation is performed on the electronic cards passing through this registering process. Other electronic cards that do not pass through the registering process cannot be used. However, one-time usable electronic cards for patients record patient information without classifying patients.

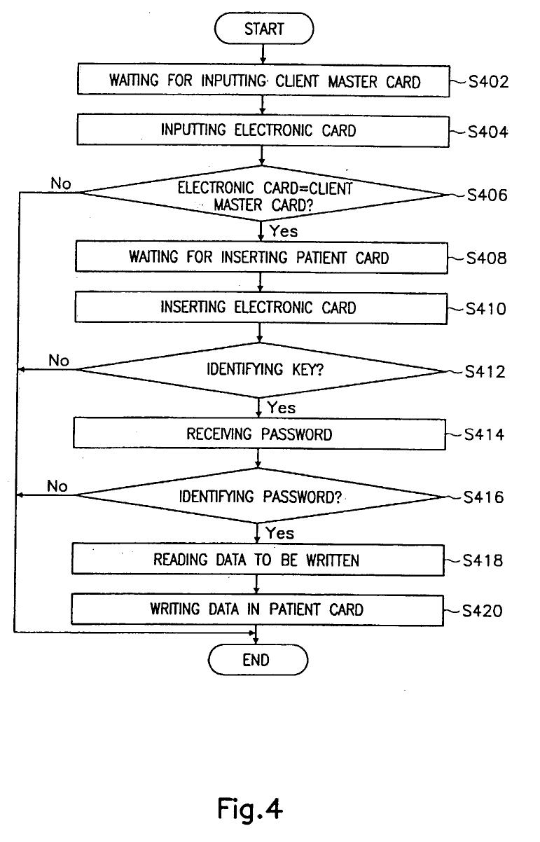

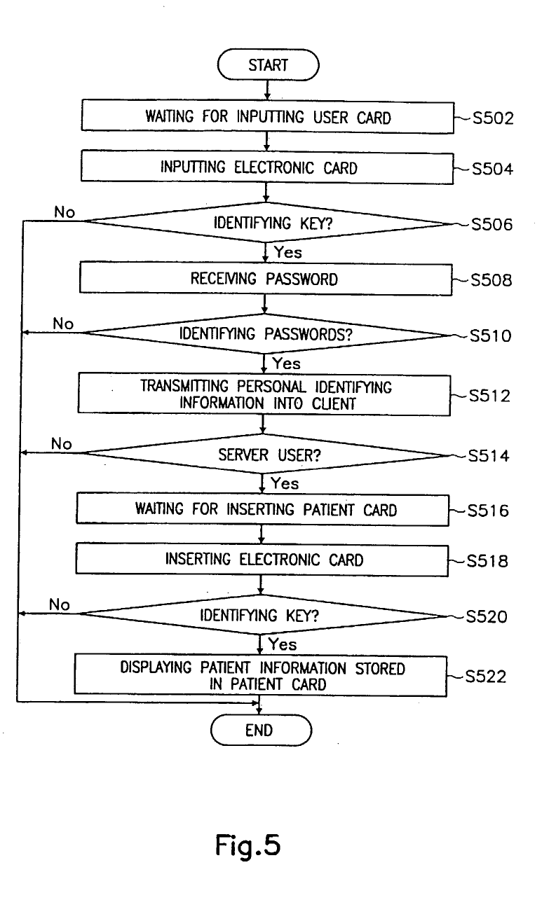

The write and inquiry operation on the patient cards or user cards is performed via the main server 12 or the client 20. Referring to FIGS. 4 and 5, the process of performing the write and inquiry is explained in the present invention.

FIG. 4 is a flow chart for explaining a process of writing predetermined information on patient cards in a method of providing medical service using electronic cards in accordance with a preferred embodiment of the present invention.

When the operator terminal 40 selects a write function, an applied program of the client 20 calls the input of client master cards to the operator terminal 40, and waits for the input of the client master cards (S402).

If predetermined electronic cards are inputted via the card reader 30 connected to the client 20 under this condition (S404), the electronic card 100 and the client 20 ascertain whether the inputted electronic card 100 is a client master card (S406).

The judging procedure of S406 is identical with the steps of S206˜S216 in FIG. 2. In the step of S216, whether priority information written in the electronic card is registered as a client server is judged. As a result, whether the electronic card 100 is a client master card is confirmed.

As a result of judgment in S406, if the electronic card 100 is judged as a client master card (Yes), an applied program calls an input of patient cards to the operator terminal 40 and waits for the input of the patient cards (S408).

When the predetermined electronic card 100 is inputted via the card reader 30, the client 20 and the electronic card 100 perform the certification procedure using certification keys. If a message for approving certification of certification keys is transmitted from the electronic card 100 (Yes in S412), the client 20 calls an input of passwords to the operator terminal 40 and receives the passwords that patients register (S414).

The inputted password is transmitted to the electronic card 100 via the client 20. The electronic card 100 judges whether the inputted password is identical with a password registered in the process of issuing new cards (S416). As a result of the judgment, if both passwords are identical, a message for approving certification of the password is transmitted to the client 20 (Yes in S416). The client 20 receiving the message for approving certification of the password calls a transmission of data to be written to the main server 12. The main server 12 reads health information on relevant patients stored in the hospital system 10, and then transmits the information to the client 20.

Here, the health information read in the hospital system 10 is information on emergency, vaccination, medical history, emergency records, medical treatment, prescription, examination and medication. These data is written in the patient cards via the card reader 30 (S420).

The main server 12 stores the health information on patients read from the hospital system 10 in the database 14. It is desirable that the same data of the database 14 as the data stored in the patient cards should be written.

FIG. 5 shows the process of inquiring the data stored in patient cards 100.

If the operator terminal 40 formed in the client 20 selects an inquiry function, an applied program formed in the client 20 calls an input of user cards to the operator terminal 40 and waits for the input of the user cards (S502).

Here, the user cards are cards that persons involved in medical treatment such as physicians and nurses belong to.

When predetermined electronic cards are inserted via the card reader 30 connected to the client 20 (S504), the electronic card 100 and the client 20 perform the certification procedure using certification keys. If a message for approving certification of certification keys transmitted in the electronic card 100(Yes in S506), the client 20 receives passwords of users via the operator terminal 40 (S508) and transmits the passwords to the electronic card 100 via the card reader 30.

The electronic card 100 performs the certification procedure using passwords. As a result, if both passwords are identical (Yes in S510), a message for approving certification of passwords and the previously stored personal identification information such as personnel numbers are transmitted (S512).

The client 20 receiving the personal identification information transmits the personal identification information to the main server 12. The main server 12 judges whether a user corresponding to the personal identification information is registered as a user in the server using user information stored in the database 14 (S514).

As a result, if user information corresponding to the personal identification information is stored in the database 14, the user is registered in the server and judged as a user having an inquiry right (Yes in S514). Then, a message for approving certification of inquiry rights is transmitted to the client 20.

The client 20 receiving the message for approving certification of inquiry rights calls an insertion of patient cards via the operator terminal 40, and then an input of the patient cards (S516).

After the predetermined electronic card is inputted according to the request, the certification procedure is performed using certification keys. If the certification procedure succeeds, that is, the certification key stored in the client is identical with the certification key stored in the electronic card (Yes in S502) , the electronic card is identified as patient cards. After information stored in the patient cards is read and displayed to the operator terminal 40, the user is allowed to inquire the patient information.

In the preferred embodiment of the present invention, the users can inquire patient information stored in the patient cards only when users input patient cards. However, there is another way to display patient information. For example, a user inputs personal information on patients such as names or identification numbers, the client 20 transmits patient identification information to the main server 12. Then, the main server 12 inquires the patient information and transmits the inquired information to the client 20. The patient information inquired in the operator terminal 40 by the client 20 can be displayed.

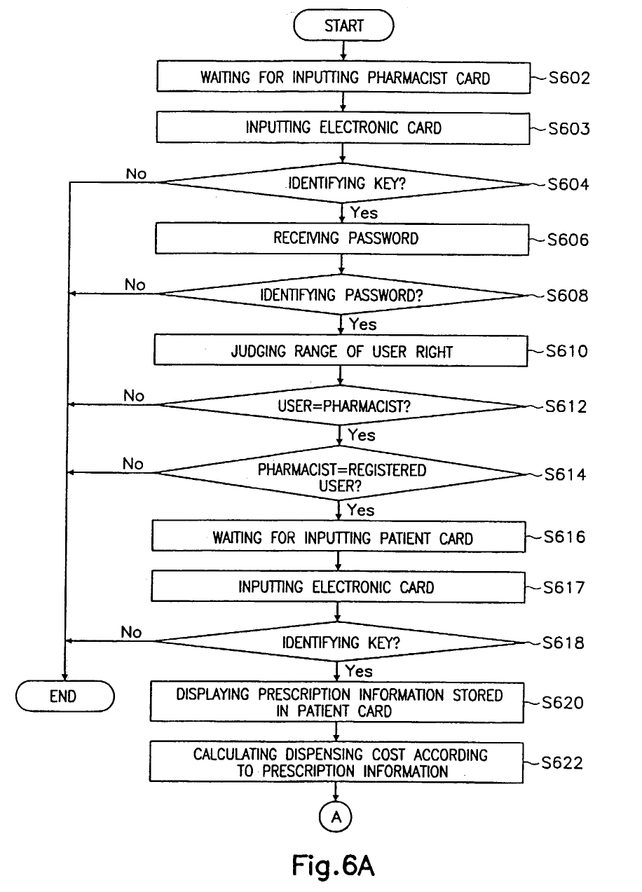

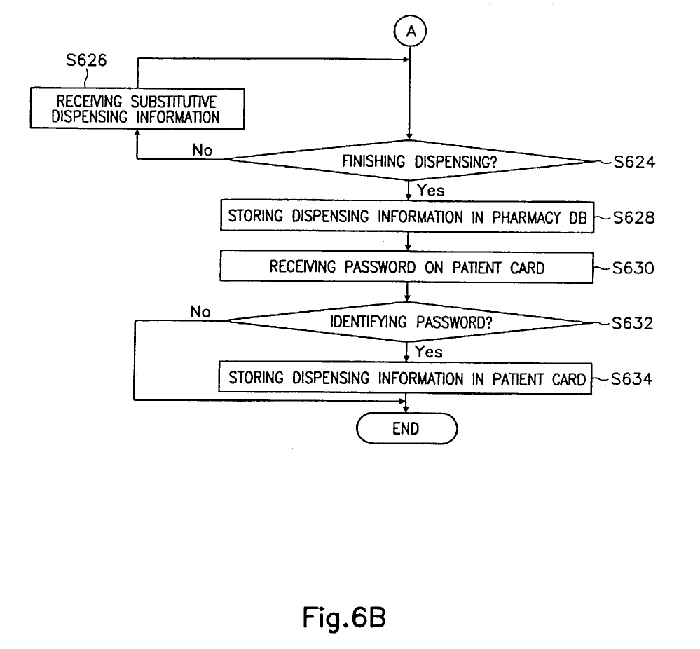

By the above-described process, if a patient having an electronic card receiving prescription records visits a pharmacy and shows the electronic card, a pharmacist dispenses drug according to the prescription records inputted in the electronic card. This procedure is shown in a flow chart of FIG. 6.

If a dispensing command is inputted via an operator terminal 64 connected to a pharmacy client 60, the client 60 calls an input of a user card as a pharmacist (hereinafter, referred to a pharmacist card) by an applied program installed in the client 60, and waits for the input of the pharmacist card (S602).

After the electronic card 100 is inputted via a card reader 70 of the client 60 (S603), the client 60 and the electronic card 100 perform the certification procedure using certification keys. Then, they judge whether a certification key registered in the client 60 is identical with a certification key stored in the electronic card 100 (S604).

If both certification keys are identical, a message for approving certification of certification keys is transmitted from the electronic card 100 (Yes in S604). Then, the client 60 receives a password via the operator terminal 64 (S606), and the inputted password is transmitted to the electronic card 100. The electronic card 100 judges whether a password stored in an element file is identical with a password inputted via the operator terminal 64 (S608).

As a result of judgment in the electronic card 100, if both password are identical (Yes in S608), the electronic card 100 transmits a message for approving certification of passwords, personal identification information stored in the element file and priority information to the client 60.

The client 60 judges the ranges of user rights of the electronic card, based on the priority information (S610), and then identifies if a user right of the electronic card is a pharmacist (S612). As a result of the identification, if the user right of the electronic card is registered as pharmacists (Yes in S612), the client 60 judges whether the pharmacist is a user registered in a database 62 using the personal identification information (S614).

If the pharmacist is identified as the user registered in the database 62 (Yes in S614), the client 60 calls an input of a patient card via the operator terminal 64 and then waits for the input of the patient card (S616).

If a predetermined electronic card is inputted to a card reader 70 (S617), the electronic card and the client 60 perform the certification procedure using certification keys. As a result of the certification procedure, if a certification key stored in the electronic card is identical with a certification key registered in the client 60, the electronic card 100 transmits a message for approving certification of certification keys to the client 60 (Yes in S618).

The client 60 receiving the message for approving certification of the certification keys reads prescription information stored in patient cards, and displays the information to the operator terminal 64 (S620). The client 60 calculates automatically dispensing cost in consideration of unit prices and quantity of drugs included in the prescription information, and then outputs the dispensing cost to the operator terminal 64 (S622). Here, the unit price of the drugs is stored in the database 62 as a unit price corresponding to each drug code according to a standardized code system, thereby resulting in calculation of dispensing cost.

Hereinafter, the client 60 judges whether completion of dispensing is inputted from the operator terminal 64 (S624). If an alternative dispensing information is inputted without an input of the completion of dispensing (S626), the step moves back to the step of S624, and the client 60 judges again if the completion of dispensing is inputted from the operator terminal 64.

When the completion of dispensing is inputted from the operator terminal 64, the client 60 stores the information on dispensing records in the pharmacy database 62 (S628). Then, a password on the patient card is inputted via the operator terminal 64 (S630).

If the client 60 transmits the inputted password to the patient card, the patient card judges if the password is identical with a password stored in an element file (S632). When both passwords are identical (Yes in S632), a message for approving certification of passwords is transmitted to the client 60.

The client 60 receiving the message for approving certification of passwords finishes the process of dispensing in the pharmacy by storing the dispensing information in the patient card (S634). Here, the patient card stores information on dispensing records, dispensing costs and individuals (names of pharmacists) of pharmacist cards inputted in the step of S603.

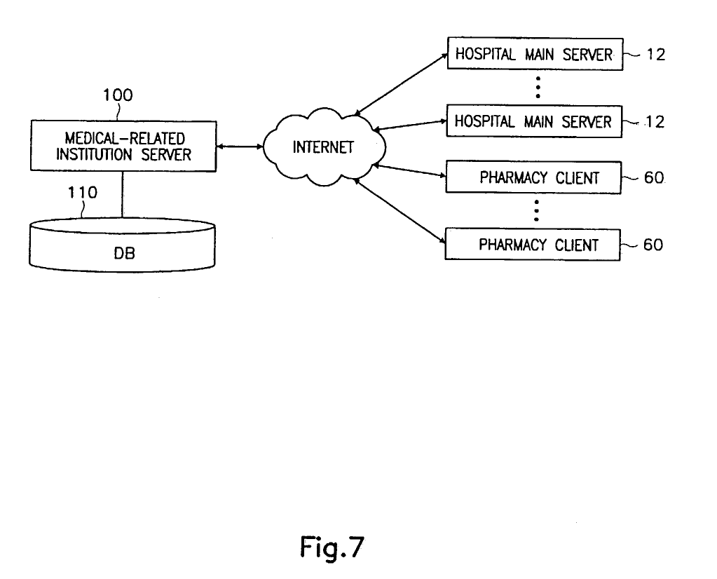

FIG. 7 is a block diagram illustrating a system for providing medical service using electronic cards in accordance with another preferred embodiment of the present invention. As shown in FIG. 7, the hospital main server 12, the pharmacist client 60 and the medical-related institution server 100 shown in FIG. 1 are inter-connected to each other via the Internet.

The medical-related institution server 100 connected to the hospital main server 12 and the pharmacy client 60 receives patient information according to records of medical treatment from the hospital main server 12 and the pharmacist client 60. The server 100 stores the patient information in a database 110 and informs patients of the information.

The server 100 compares records of medical treatment transmitted from the hospital main server 12 with those of medical treatment transmitted from the pharmacist client 60, and judge whether records of medical treatment are proper or not. The server 100 is formed in authorized institutions such as National Health Insurance Cooperation administered by government, private insurance cooperation, central medical management institutions. In this way, it is desirable to share personal health information.

The server 100 can receive on real time the patient information according to records of medical treatment from the hospital main server 12 and the pharmacy client 60, whenever medical treatment cost or dispensing cost is generated. In other way, the server 100 can also receive the patient information according to records of medical treatment periodically.

The server 100 comprises a card reader capable of reading IC cards as not shown in FIG. 7.

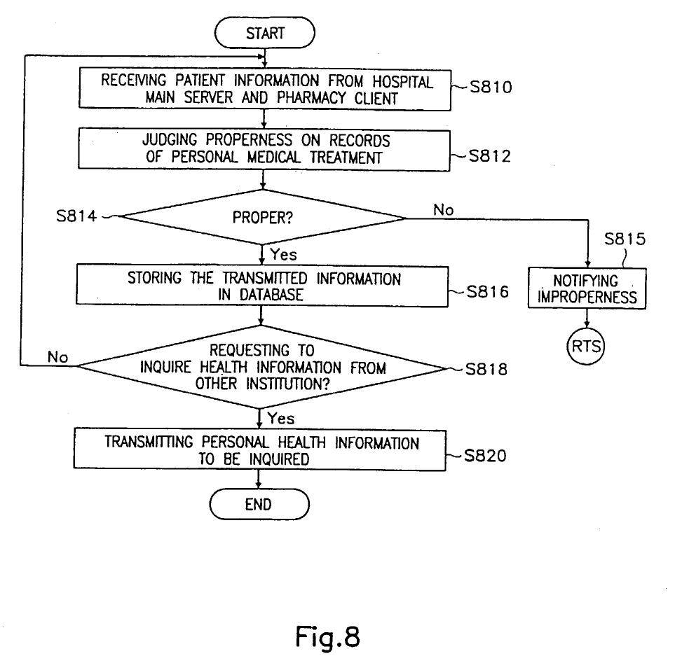

Hereinafter, a method of administering on-line health information of patients using electronic cards in accordance with a preferred embodiment of the present invention is now explained with reference to a flow chart of FIG. 8.

In FIG. 8, the server 100 collects information from the hospital main server 12 and the pharmacy client 60, and administers personal health information collectively.

When receiving patient information according to records of medical treatment from the hospital main server 12 and the pharmacy client 60 (S810), the server 100 judges whether the records of medical treatment are proper or not (S812). For example, if the server 100 confirms if prescription information on patients transmitted from hospital is identical with dispensing information transmitted from pharmacy, whether the records of medical treatment of the relevant patients are proper or not can be judged.

However, if judging that the records of medical treatment are not proper (No in S814), the server 100 informs hospital and pharmacy of impropriety (S815). On the other hand, if judging that the records of medical treatment on patients are proper (Yes in S814), the server 100 classifies transmitted patient information by patients and then stores the information in a database 110 (S816).

When an inquiry of health information on a specific person is requested from other institutions (Yes in S818), the server 100 checks the condition of qualification of relevant institutions. If judging that the relevant institutions are qualified for inquiry of health information, the server 100 calls the health information of a relevant patient stored in the database 110 and then transmits the information to other institutions (S820).

According to these functions of the present invention, private insurance institutions can secure precise health information of specific persons. The authorized institutions can also share the precise health information of specific persons, thereby resulting in administering the personal health information systematically.

As not shown in FIG. 8, the medical-related institutions server 100 inform each patient of the collected records of medical treatment periodically. As a result, the patients can confirm their records of medical treatment periodically.

The personal health information can be transmitted via encryption between hospital main servers connected to each other via the Internet or between medical-related institution servers and hospital main servers. Here, the encryption applies the same protocol to transmitting institutions and receiving institutions, and encodes health information which is a transmitting object, thereby resulting in transmitting the information. On the receiving side, the information is decoded again. Additionally, the health information of the patients which is a transmitting object is encoded and transmitted using key values recorded in patient electronic cards. On the receiving side, the encoded and transmitted patient health information is decoded by using the electronic cards. In the latter method, the reliability of transmitting information can be improved because the health information can be transmitted only when a person corresponding to the health information to be transmitted shows his or her electronic card.

Electronic cards according to the present invention serve as lifelong health record cards of patients because detail information of the patients are recorded in patient cards. The electronic cards also help physicians or pharmacists to treat the patients or dispense drugs, thereby resulting in establishment of systems of transmitting medical information efficiently and improvement of medical service.

Personal information of patients stored in patient cards can be secured safely because users such as pharmacists, physicians and nurses are allowed to record and inquire patient cards. As a result, patients can use the electronic cards safely.

Unless persons having patient cards, user cards or master cards are authorized by passwords or key values of each card, they are not allowed to record and inquire patient information. In the present invention, there is provided the electronic cards having this reliable certification system. As a result, anyone can use these electronic cards safely.

In addition, it is possible to provide swift and precise medical service because medical information such as past records of medical treatment of relevant patients can be seized when medical institutions permanently store patient information of individuals or emergent conditions occur.

What is claimed is:

1. A system for providing medical service using electronic cards comprising hospital system for previously storing the information on patients having records of medical treatment and on users (physicians, nurses, pharmacists) involved in practice of medical treatment, including:
electronic cards issued according to rights of users and for recording various information on medical service for patients;
a main server of hospital for registering new electronic cards and inquiring•recording the registered electronic cards after storing the information of the hospital system in a separate database;
a hospital client connected to the main server, and for registering new electronic cards and inquiring•recording the registered electronic cards; and
a pharmacy client for inquiring the prescription information recorded in patient cards and recording the dispensing information on the prescription information in the patient cards;
wherein the main server and the clients include a card reader for reading the information stored in the electronic cards and recording predetermined information in the cards, and an operator terminal for inputting instruction and outputting the process of instruction execution.

2. The system according to claim 1, wherein the card reader installed in the main server and the clients is one or more.

3. The system according to claim 1, wherein the electronic card has a built-in IC chip.

4. The system according to claim 1, wherein the hospital client is installed in such places in hospitals as a medical office, a reception counter, a dispensary, an emergency room and an examination room.

5. The system according to claim 1, wherein the main server classifies rights of the electronic card users after registering new electronic cards into patient cards or user cards.

6. The system according to claim 1, wherein the hospital client registers new electronic cards into patient cards.

7. The system according to claim 1, wherein the main server transforms the information stored in the hospital system into the authorized standardization codes and then stores the codes in a database.

8. The system according to claim 7, wherein the standardization codes are the standardized system of authorized codes applicable to other medical institution in common.

9. The system according to claim 1, wherein the pharmacy client is connected to the main server through the Internet.

10. The system according to claim 9, wherein the pharmacy client transmits the dispensing information stored in the patient cards and then real-time stores the dispensing information in a database formed in the main server.

11. The system according to claim 1, wherein the information recorded in the electronic cards includes the information on users, individuals, clients, medical insurance, medical treatment, medication, emergency, medical treatment right, medical treatment record and examination.

12. The system according to claim 1, wherein the electronic card is united with the banking card.

13. The system according to claim 12, wherein the essential file for recording various information for medical treatment of patients is stored in a predetermined dedicated file ‘DF’ of the banking card, and the banking card is united with the electronic card.

14. A method. of providing medical service using electronic cards comprising hospital system for storing the information on users (physicians, nurses, pharmacists) involved in medical practice and on patients having records of medical treatment, including:
the first step of transforming the information stored in the hospital system into the standardization codes and then storing the standardization codes;
the second step of enabling users having registering rights to register new electronic cards into user cards or patient cards; and
the third step of transmitting the electric medical information on users of the registered cards.

15. The method according to claim 14, wherein the standardization code of the first step is the standardized code system applicable to other medical institution.

16. The method according to claim 14, wherein the first step is performed when a master card for server succeeds in certification to administer the main server for administering the database.

17. The method according to claim 16, wherein a card to be certificated succeeds in certification using an authorized key and a password, and the master card for server succeeds in certification when the right of the card is registered into a master card for server.

18. The method according to claim 14, wherein registration rights are authorized to master cards of a main server for administering the database (a master card for server) and of a hospital client connected to the main server (a master card for client).

19. The method according to claim 18, wherein the main server registers new electronic cards into user cards or patient cards when the server master card succeeds in certification.

20. The method according to claim 18, wherein the hospital client registers new electronic cards into patient cards when the client master card succeeds in certification.

21. The method according to claim 14, wherein a process of transmitting electronic medical information in the third step is to inquire information stored in patient cards when user cards succeeds in certification.

22. The method according to claim 14, wherein a process of transmitting electronic medical information in the third step is to record predetermined information using patient cards when cards having the registration rights succeed in certification.

23. The method according to claim 14, wherein a process of transmitting electronic medical information in the third step is to dispense medicine in a hospital client using prescription information stored in patient cards, and then to store a dispensing result in the patient cards.

24. The method according to claims 22 or 23, wherein the patient cards allows predetermined information to be stored therein only when the patient cards succeed in certification using password.

25. A method of providing medical service using electronic cards in (1) a hospital main server for registering new electronic cards, inquiring the registered cards and recording details of medical treatment, (2) a pharmacy client for inquiring prescription information recorded in patient cards and storing dispensing information on the prescription information in the patient cards and (3) a system connected to medical institution for administering details of medical treatment of patients using the Internet, including:
the first step of transmitting patient information according to details of medical treatment from the hospital main server and the pharmacy client to the medical institution;
the second step of determining properness of the transmitted patient information, classifying the legitimate patient information by patients and storing the information in the medical institution; and
the third step of certifying rights of inquiring the medical institution when the inquiry of patient information on a specific patient is required from other institution connected to the medical institution through the Internet, and of transmitting the previously stored information on a relevant patient into the institution when the institution is determined as an institution having inquiry right.

26. The method according to claim 25, wherein the medical institution of the second step compares the patient information transmitted from the hospital client with the patient information transmitted from the pharmacy client, and then determines the properness.

27. A method of providing medical service using the system wherein servers for administering health information of patients are installed in a plurality of hospitals, a plurality of pharmacies and a plurality of medical institutions, respectively, the servers connected through the Internet are installed, and electronic cards having individually allotted values of specific keys are issued to according to the patients, including:
the first step of enciphering health information corresponding to the patients using the values of the keys allotted in electronic cards issued to the patients and then transmitting the information into a relevant server in a predetermined transmission server for transmitting the information corresponding to the patients; and
the second step of decoding the transmitted health information using the values of keys allotted in electronic cards issued to the patients and then certifying the information in the relevant server.

28. The method according to claim 27, wherein the health information includes information on users, individuals, priority, medical insurance, medical treatment, medication, emergency, right of medical treatment, record of medical treatment and examination.
